(19) United States
(12) Patent Application Publication
(10) Pub. No.: US 2011/0135471 A1
(43) Pub. Date: Jun. 9, 2011

(54) Wind Turbine

(76) Inventor: Jonathan Graham Wangford, Auckland (NZ)

(21) Appl. No.: 12/996,912

(22) PCT Filed: Jun. 12, 2008
(86) PCT No.: PCT/NZ08/00143

§ 371 Date: Dec. 8, 2010

(30) Foreign Application Priority Data
Jun. 12, 2007 (NZ) 555848

(51) Int. Cl. F03D 3/06; F03D 9/00; B64C 11/06; B64C 11/00

(52) U.S. Cl. 416/17; 290/55; 416/147; 416/153

(57) ABSTRACT

A wind turbine has a plurality of feathering blades and a governor for controlling the pitch angle of the blades according to the speed of rotation of the turbine. An elastic linkage connects between the governor and the blades. The linkage urges the blades toward the pitch position set by the governor. The linkage allows pitching of the blades toward a more feathered position than a position set by the governor against the elastic return force. The linkage does not allow substantial pitching of the blades to a less feathered position than the position set by the governor, lne centrifugal governor sets the minimum pitch angle of the blades, but the blades can react immediately to additional wind pressure by self feathering against the urging of the elastic linkage.

### FIELD OF THE INVENTION

The present invention relates to wind turbines and in particular to systems for starting and protecting wind turbines in strong winds.

### BACKGROUND ART

Small and micro wind turbines generally incorporate an AC generator for generating electrical power. Commonly these generators are direct drive with axial flux and consist of one or more rotors comprised of a flat circular plate with magnets mounted radially at regular intervals. Located proximate the rotor is a stator. Generally the stator includes a series of coils spaced to coincide with the magnets of the corresponding rotor or rotors. In use, the changing magnetic flux created by the magnets rotating with the rotor induces a current in the stator coils.

Generators of this type are often subject to an effect called “cogging”, which is caused by the magnets interacting with the stator iron core. Cogging produces a resistance to the initial rotation of the wind turbine. There are also resistive forces arising from magnetic induction of current in the coils. These resistive forces can prevent rotation of the wind turbine at low wind speeds. The critical value of wind speed at which the turbine starts to rotate is known as the breakaway speed. As an example, a turbine may require a 10 km/h wind to initiate rotation, but may be able to sustain rotation at lower wind speeds. Some small wind turbine manufacturers overcome the effects of cogging by motoring the turbine for a few seconds every minute. This can provide sufficient energy to overcome the resistive forces and start rotation of the turbine. However this is not an ideal solution.

Small and micro wind turbines also require a system to limit the maximum rotational speed of the turbine to prevent the components and supporting structure being subjected to excessive stress. The most common method employed is a furling system, whereby the turbine turns out of the wind by either yawing to the left or the right or pitching vertically upwards. The furling method is the simplest form of over-speed protection. However, the method is noisy, relatively crude and subjects the turbine and supporting structure to considerable stress. This is especially the case in gusty, turbulent conditions. Furthermore, high gyroscopic forces are present when a turbine, is spinning at maximum speed. This can result in sudden and repeated yawing or pitching through angles of 60 to 90°.

A more advanced method of controlling the turbine rotational speed involves altering the pitch of the turbine blades. One variant of this method involves decreasing the turbine blade pitch as the rotational speed of the turbine increases this generally causes the blades to stall and slow down. An alternative method is to increase blade pitch (toward “feather”), as this allows the generator to continue producing power regardless of the wind speed. Both the furling and stalling systems effectively terminate power generation in strong winds.

Blade pitch control design is complex. One significant drawback is that the wind turbine cannot react quickly to rapid increases in wind speed such as strong gusts of wind. This is due to the inertia of the centrifugal governor system commonly used to control the blade pitch. The governor in an increasing pitch system causes the turbine blades to rotate towards feather as the rotational speed of the turbine approaches the maximum design speed. This permits the turbine to maintain a speed very close to the maximum design speed, which is referred to as “constant speeding”. Hence, any further increase in wind speed will not increase the rotational speed of the turbine. However, in preferred wind conditions the turbine effectively behaves like a fixed pitch turbine. The optimum blade angle is designed for a particular range of wind speeds, with the governor operating to restrict rotation in excess of that range. Turbines incorporating these systems are therefore vulnerable to sudden wind gusts.

For example, if the maximum turbine design speed is set to 1000 RPM (which is reached at a steady 65 km/h wind speed), in prevailing wind conditions of 40 km/h the turbine may be rotating at approximately 600 RPM. In a sudden wind gust of 70 km/h, the turbine will be subjected to a horizontal force in excess of the design conditions. The simple furling type turbine would immediately turn out of wind, avoiding the excessive horizontal forces. However, the pitch control turbine must accelerate to the pitching speed of 1000 RPM before any relief is achieved. Even when operating in the “constant speeding” RPM range, it would still require a small RPM increase to cause the pitching mechanism (flyweight governor) to react to the wind gust forces. As a result, pitch controlled wind turbines are generally constructed to withstand greater wind forces.

Additionally, there are occasions of extreme wind conditions in which turbines of any design are unable to cope. In these situations the only option is to shut down the turbine completely. This generally requires manual intervention. As such, a surprise storm can have a devastating effect on an unsupervised wind turbine.

It is an object of the present invention to provide a wind turbine which goes some way to overcoming one or more of the above disadvantages or which will at least provide the public or industry with a useful choice.

### SUMMARY OF THE INVENTION

In a first aspect the invention consist in a wind turbine comprising a plurality of feathering blades and a governor for controlling the pitch angle of the blades according to the speed of rotation of the turbine, and an elastic linkage between the governor and the blades, the linkage urging the blades toward the pitch position set by the governor, allowing pitching of the blades toward a more feathered position than a position set by the governor against the elastic return force, and not allowing substantial pitching of the blades to a less feathered position than the position set by the governor; such that the centrifugal governor sets the minimum pitch angle of the blades, but the blades can react immediately to additional wind pressure by self feathering against the urging of the elastic linkage.

In a further aspect the linkage acts on the blades collectively.

In a further aspect the blades are mounted in a hub, each blade to rotate around a respective pitch axis, the governor includes a pitch control member, the position of the pitch control member relative to the hub changes according to turbine speed, and the linkage includes a blade control member, the position of the blade control member relative to the hub changing according to blade pitch of the blades, the position of the pitch control member setting an limit position for the blade control member, and a spring urging the blade control member toward this limit position, and providing a preload force against movement of the blade control member away from this limit position.

In a further aspect each blade includes a shape having a leading and a trailing edge, and the blade has a centre of pressure that is displaced from the blade pitch axis in the direction of the trailing edge of the blade so that wind force on the blade urges feathering of the blade.

In a further aspect each blade is balanced such that centrifugal turning moment around the pitch axis of the blade, generated by rotation of the turbine, at speeds throughout the useful speed range for the turbine is more than countered by the moment provided by wind force on the blade at that speed.

In a further aspect each blade includes a blade body and a counter weight near the root of each blade body sized and located to balance the centrifugal turning moment of the blade.

In a further aspect the pitch axes of each blade all fall in a single plane.

In a further aspect the governor includes a plurality of pivoting flyweights, that orbit around the rotation axis of the hub, and the flyweights can move outward against a spring force with increasing rotation speed of the hub, outward position of the flyweights controlling the position of the pitch control member.

In a further aspect a drive shaft extends from the hub, the governor includes a plurality of flyweights pivotably connected to the drive shaft and interconnected to the pitch control member by a plurality of links, and

the pitch control member is able to move along the axis of the drive shaft, and the position of the pitch control member along the drive shaft is controlled by the outward displacement of the flyweights.

In a further aspect the governor includes a partially compressed spring acting on the pitch control member urging the pitch control member toward an unfeathered position.

In a further aspect the blade control member is able to move along the axis of the drive shaft and a partially compressed spring acts between the blade control member and the pitch control member.

In a further aspect the blade control member is a sleeve concentric with the pitch control member and able to slide along the pitch control member, and abuts a portion of the pitch control member at one end of the sliding movement, the partially compressed spring urging the blade control member to this end.

In a further aspect the partially compressed spring is compressed between a collar on the pitch control member and a portion of the sleeve.

In a further aspect the spring urging the pitch control member to the unfeathered position is stiffer than the spring acting between the pitch control member and the blade control member.

In a further aspect a drive shaft extends from the hub,

the governor includes a plurality of flyweights pivotably connected to the drive shaft or hub to swing outward about a hinge axis parallel with the drive shaft rotation axis, and interconnected to the pitch control member by a plurality of links, and

the pitch control member is annular and is able to rotate around the axis of the drive shaft, and the rotational position of the pitch control member around the drive shaft is controlled by the outward displacement of the flyweights.

In a further aspect the governor includes a preloaded torsion spring acting on the pitch control member urging the pitch control member toward an unfeathered rotational position.

In a further aspect the blade control member is annular and is able to rotate around the axis of the drive shaft and a preloaded torsion spring acts on the blade control member urging the blade control member to an unfeathered condition.

In a further aspect the blade control member is annular and is able to rotate around the axis of the drive shaft and a preloaded torsion spring acts on the blade control member urging the blade control member to an unfeathered condition, and the spring urging the pitch control member to the unfeathered position is stiffer than the spring acting to urge the blade control member toward the unfeathered condition.

In a further aspect the torsion spring acting on the blade control member is constrained at one end by a sleeve concentric with the shaft and the sleeve is usually locked to rotate with the shaft, the turbine including a release control to release the sleeve to rotate relative to the shaft.

In a further aspect the torsion spring acting on the blade control member is constrained at one end by a sleeve concentric with the shaft and the sleeve is usually locked to rotate with the shaft, the turbine including a release control to release the sleeve to rotate relative to the shaft.

In a second aspect the invention consists in a wind turbine comprising a plurality of feathering blades, a governor for controlling the pitch angle of the blades according to the speed of rotation of the turbine, and a safety cutout mechanism including a trigger comprising a coil spring that is secured at one end to rotate around its coil axis according to rotation of the turbine, and having a weight mounted to the free end, and the safety cutout mechanism responds to bending over of the coil spring by feathering the blades; such that such that any whirling of the rotation axis of the spring tower leads to the weight orbiting the rotation axis, and if the moment created by this orbit is sufficient to break the stability of the coil, the coil bends over and the safety cutout mechanism feathers the blades.

In a further aspect the coil axis is on the rotation axis of the wind turbine.

In a further aspect adjacent coils of the coil spring are contacting each other when the spring is in a linear condition.

In a further aspect the wind turbine includes a blade control member that collectively controls the pitch angle of the blades and is elastically biased toward a position corresponding with an unfeathered position of the blades, and the safety cutout mechanism includes a linkage from the free end of the spring, which linkage releases the bias from the blade control member when the spring bends over.

In a further aspect the linkage includes a flexible non-extensile tie between the free end of the spring and a latch which can selectively release the bias from the blade control member.

In a further aspect the latch includes a piston slidable inside a cylinder, biased by a spring to a first location and movable to a second location by tension on the tie acting against the return force of the spring, locking members extending through apertures in the wall of the cylinder, the locking members being held in an outward position by the piston when the piston is in the first position, and being able to move to a more inward position when the piston is in the second position.

In a further aspect the locking members comprise locking balls, the piston includes an annular channel in a cylindrical surface of the piston that the locking balls can move into when the piston is in the second position, and the locking balls protrude from the outer surface of the cylinder when the piston is in the first position, but not when they move into the channel with the piston in the second position.

In a further aspect the bias includes a first member that is latched in a first position but movable to a second position when unlatched, and a spring acting between the first member and the blade control member, which applies substantially greater force to the blade control member when the first member is in the first position than when the blade control member is in the second position, and the linkage unlatches the first member from the first position to release the bias.

In a further aspect the bias includes a first annular member around the cylinder that is latched in a first position by the protruding locking balls when the piston is in the first position, but movable to a second position when the locking balls do not protrude, and a spring acting between the first member and the blade control member, which applies substantially greater force to the blade control member when the first member is in the first position than when the blade control member is in the second position.

In a further aspect the first member is an annular member around the rotation axis of the turbine, the blade control member is an annular member around the rotation axis of the turbine, the spring acting between the first member and the blade control member is a torsion spring, and the first member is stopped from rotating around the rotation axis of the turbine by the latch, but when the latch is released the first member is free rotate around the rotation axis of the turbine.

In a further aspect the first member moves between positions along the rotation axis of the turbine, the blade control member moves between positions along the rotation axis of the turbine, the spring acting between the first member and the blade control member is a compression spring, and the first member is stopped from moving along the rotation axis of the turbine by the latch, but when the latch is released the first member is free to move along the rotation axis of the turbine.

In a further aspect the wind turbine includes a preloaded elastic linkage between the governor and the blades, the linkage urging the blades toward the pitch position set by the governor, allowing pitching of the blades toward a more feathered position than a position set by the governor where the preload is exceeded, and not allowing pitching of the blades to a less feathered position than the position set by the governor; such that the centrifugal governor sets the minimum pitch angle of the blades, but the blades can react immediately to additional wind pressure by self feathering against the urging of the elastic linkage.

In a further aspect the linkage acts on the blades collectively.

In a further aspect the blades are mounted in a hub, each blade to rotate around a respective pitch axis, the governor includes a pitch control member, the position of the pitch control member relative to the hub changes according to turbine speed, and the linkage includes the blade control member, the position of the blade control member relative to the hub changing according to blade pitch of the blades, the position of the pitch control member setting a limit position for the blade control member, and a spring urging the blade control member toward this limit position, and providing a preload force against movement of the blade control member away from this limit position.

In a further aspect each blade includes a shape having a leading and a trailing edge, and the blade has a centre of pressure that is displaced from the blade pitch axis in the direction of the trailing edge of the blade so that wind force on the blade urges feathering of the blade.

In a further aspect each blade is balanced such that centrifugal turning moment around the pitch axis of the blade, generated by rotation of the turbine, at speeds throughout the useful speed range for the turbine is more than countered by the moment provided by wind force on the blade at that speed.

In a further aspect each blade includes a blade body and a counter weight near the root of each blade body sized and located to balance the centrifugal turning moment of the blade.

In a further aspect the pitch axes of each blade all fall in a single plane.

In a further aspect the governor includes a plurality of pivoting flyweights, that orbit around the rotation axis of the hub, and the flyweights can move outward against a spring force with increasing rotation speed of the hub, outward position of the flyweights controlling the position of the pitch control member.

In a third aspect the invention consists in a wind turbine having a plurality of blades interconnected to an electrical generator comprising:

a first rotor integral with a hub in the main body of said wind turbine and fixed to a driveshaft,

a second rotor located on a splined portion of said driveshaft and horizontally displaced by a distance from said first rotor,
an air gap formed between said first and said second rotor,

a stator having a first and a second stator surface securely located on said driveshaft and positioned equidistant in said air gap between said first and said second rotor forming a first and a second air gap,

a first spring located between said first rotor and said stator and a second spring between said second rotor with said second stator surface and each spring is biased away from said stator, a flyweight arrangement located on said driveshaft and adapted to interact with said second rotor, and

wherein said first and said second rotors are caused to rotate relative to said stator as a result of wind acting on said wind turbine causing said flyweight arrangement to act on said second rotor to force said second rotor towards said stator thereby compressing said first and second spring to reduce said air gap to enable full power to be generated by said wind turbine.

In a further aspect said air gap is a variable air gap that reduces motor start-up resistance whilst enabling full power to be generated.

In a further aspect said air gap is large enough to enable said first and said second rotors to rotate with minimal resistance during start-up.

In a further aspect said flyweight arrangement comprises at least two flyweights having an arm integral with each flyweight and having a roller integral with the end of said arm opposite said flyweights.

In a further aspect said rollers contact a rear surface of said second rotor.

In a further aspect said air gap is adapted to vary between a first separation distance and a second separation distance.

In a further aspect said first and said second spring have a biasing strength capable of over-coming a magnetic field generated between said first and said second rotor and said stator to allow said first and said second spring to return to an uncompressed state.

In a further aspect said first distance is in the range between 8 to 12 mm.

In a further aspect said second distance is about 2 mm.

### BRIEF DESCRIPTION OF THE DRAWINGS

Preferred forms of the invention will now be described with reference to the accompanying drawings in which:

FIG. 1 is an elevation of a wind turbine generator of the present invention.

FIG. 2 is a cross sectional view of the wind turbine generator of FIG. 1.

FIG. 3 is a cross sectional view of the wind turbine generator of FIG. 1 in the fully operational condition.

FIG. 4 is a plan view of a wind turbine blade including a counterweight as used in the wind turbine of the present invention.

FIG. 5 is a plan view of the wind turbine blade of FIG. 4 showing the axis of rotation of the wind turbine blade, and

FIG. 6 is a cross sectional view of the wind turbine blade of FIG. 4 showing the forces applied to the blade and counterweight.

FIG. 7 is a side view of the pitch axis of the wind turbine blade of FIG. 4.

FIG. 8 is a diagram of the wind turbine blade and counterweight of FIG. 4 illustrating the counterweight centrifugal turning moment.

FIG. 9 is a diagram of the wind turbine blade and counterweight of FIG. 4 illustrating the method for calculating torque.

FIG. 10 is a perspective view of a turbine incorporating a rotational flyweight actuator for blade pitch control according to an alternate embodiment of the present invention.

FIG. 11 is a cross-sectional side elevation of the turbine of FIG. 10.

FIG. 12 is a cross-sectional side elevation of an anti-destruction mechanism included in the turbine of FIG. 11 shown in a normal operating condition.

FIG. 13 is a cross-sectional side elevation of an anti-destruction mechanism included in the turbine of FIG. 11 shown in a triped condition.

### DETAILED DESCRIPTION OF THE INVENTION

### AC Generator

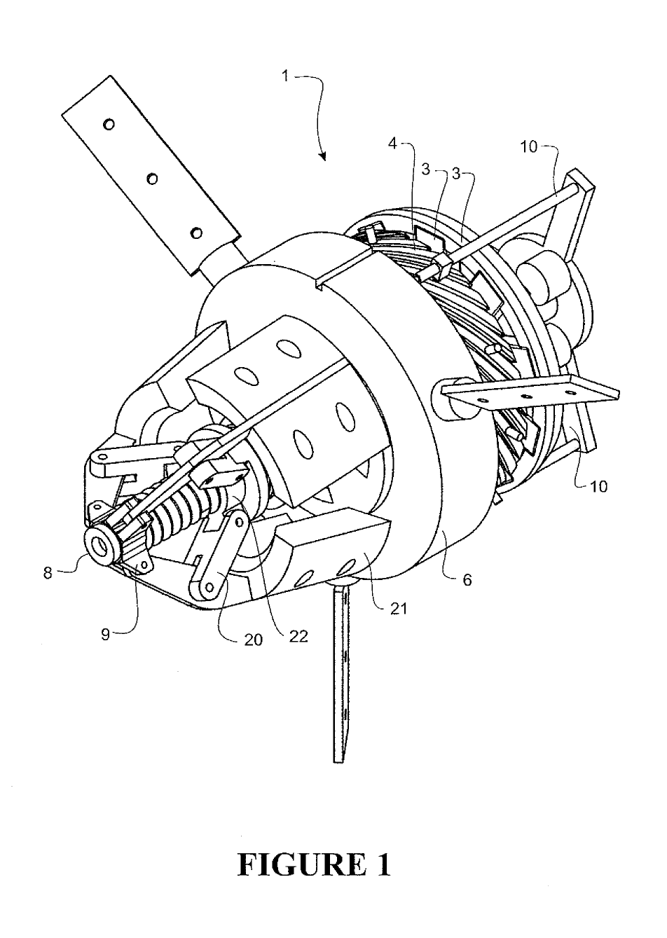

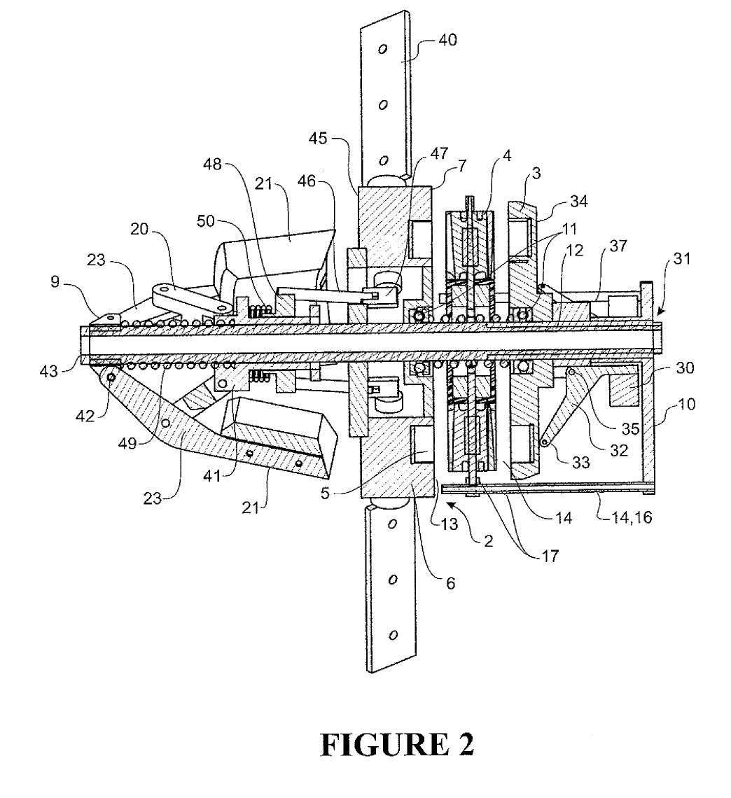

A wind turbine according to a first embodiment of the present invention is pictured in FIGS. 1 and 2. The turbine includes a generator 1, flyweights 21 and main hub 6 located about a central shaft 43. In operation the turbine blades (not shown), which connect to blade supports 40, receives kinetic energy from the wind and cause hub 6, flyweights 21, and shaft 43 to rotate about an axis substantially aligned with shaft 43. The rotation of shaft 43 causes rotators 2, 3 of generator 1 to rotate.

Common AC generators used in wind turbines have a fixed gap (typically about 2 mm) between the rotor and stator. This gap is referred to as the air gap. The size of the air gap affects the strength of attraction between the permanent magnets of the rotor and the iron cores of the stator. Increasing the air gap results in a diminished magnetic flux intensity and reduces resistance to rotation. However, a larger air gap results in reduced generator efficiency.

The AC generator of the present invention uses a variable air gap to reduce the motor start-up resistance and at the same time enable full power generation. The generator 1 of the present invention preferably has two rotors 2, 3 with a stator 4 located between them as shown in FIGS. 1 and 2. In this embodiment, the forward rotor 2 is formed by a number of magnets 5 located in close proximity around the periphery in the aft face 7 of the hub 6. Driveshaft 43 extends from collar 9 (at the front or forward part of the wind turbine directed into the wind) and extends aft to where it is attached to the guide rod support plate 10. The driveshaft 43 is supported by bearings (not shown) within the body of the generator 1.

The stator 4 is located aft (towards the guide rod support plate 10) of the forward rotor 2, and is separated from the forward rotor 2 by a first air gap 13. Aft of the stator 4 is a second air gap 14, preferably of similar proportion to the first air gap, beyond which is the aft rotor 3. The portion of driveshaft 43 which accommodates aft rotor 3 includes a splined section 12. The splined portion 12 of driveshaft 43 permits aft rotor 3 to slide or translate fore and aft whilst being driven or rotated by driveshaft 43.

Between forward rotor 2, stator 4 and aft rotor 3 are two compression springs 15 that are used to keep the motor components apart. Thrust bearings 11 are fitted to each of the rotors 2, 3 which bear against the two compression springs 15 and allow each of the rotors 2, 3 to rotate relative to the stator 4.

Aft of the aft rotor 3 is the main body (not shown) that includes a guide rod support plate 10. Extending from the support plate 10 forward is a number of stator guide rods 16. It is preferable that a minimum of three rods 16 extend from the support plate 10 and lie in a plane substantially parallel to the driveshaft 43. Each of the guide rods 16 are located within corresponding openings or holes 17 in supporting blocks 18 attached to the circumference of the stator 4. These rods 16 are used to locate the stator 4 in the correct orientation between the rotors 2, 3 and at the same time prevent the stator 4 from rotating on driveshaft 43. Supporting blocks 18 are slidably engaged with guide rods 16 to enable the stator 4 to move fore and aft within the air gaps 13, 14.

The two compression springs 15 are preferably of equal size and strength so as to separate the rotors 2, 3 by substantially equal portions from stator 4, providing an evenly spaced total air gap 13, 14 of between 8-12 mm. An air gap of 10 mm is preferable when the turbine is not rotating, or rotating at low speeds. This relatively large air gap 13, 14 allows the rotors 2, 3 to turn with minimal resistance during start-up of the turbine. By forcing the aft rotor 3 forward, compression springs 15 will compress and the air gaps 13, 14 between rotors 2, 3 and the stator 4 will reduce. In the preferred embodiment, compression springs 15 are evenly sized and compress at the same rate, which permits air gaps 13, 14 to contract at the same rate. When the force on aft rotor 3 is released, compression springs 15 force stator 4 and rotors 2, 3 apart and restore air gaps 13, 14 to the low speed state (in the order of 10 mm). Compression springs 15 must be sufficient strength to overcome the magnetic attraction generated between the rotors 2, 3 and the stator 4 during periods of reduced air gaps 13, 14.

Movement of aft rotor 3 is provided by a second flyweight arrangement. Immediately aft of aft rotor 3 is a centrifugal flyweight arrangement 30 located towards the aft end 31 of the driveshaft 43. Each flyweight 30 is connected to a corresponding flyweight arm 32, which is in turn pivoted about pivot point 35 located on generator flyweight collar 37. The motion of generator flyweight collar 37 is fixed relative to drive shaft 43. The end of flyweight arm 32 distal flyweights 30 incorporates rollers 33 which contact the aft surface 34 of the aft rotor 3. As the turbine rotates, flyweights 30 are forced outward from driveshaft 43 by the centrifugal force of rotation. This motion causes the rollers 33 to move inwardly toward driveshaft 34 along the aft surface 34 of aft rotor 3, which forces aft rotor 3 to move forward towards the stator 4. Therefore, as the turbine rotational speed increases, the centrifugal force acting on flyweights 21 increases until it is great enough to overcome the force of springs 15, causing them to compress. As a result the air gaps 13, 14 are reduced from between 8-12 mm to approximately 2 mm in the preferred embodiments. Hence, the wind turbine can start-up at a much lower breakaway speed while still being capable of efficient power generation.

### Gust Relief Protection

The gust relief protection system of the present invention provides a mechanism for pitch controlled wind turbines to relieve the horizontal forces associated with sudden wind gusts. The system incorporates a centrifugal governor which is located in the nose cone (not shown) forward of the turbine hub 6 and attached to blade support shafts 40. The governor rotates at the same speed and on the same axis as the turbine, and is mounted on an extension of the generator drive shaft 43.

A first embodiment of the gust relief protection system is pictured in FIG. 2. Flyweights 21 are attached by a hinged joint 42 to a collar 9 which is fixed to driveshaft 43. Another link 20 connects the flyweights 21 to a carriage 41 which incorporates a bearing (not seen) allowing the carriage 41 to slide fore and aft on the driveshaft 43. Outwards movement of the flyweights 21 (as a result of the centrifugal force of rotation) translates into forward movement (away from the hub 6) of the carriage 41. Mounted on driveshaft 43 between carriage 21 and flyweight collar 9, is a compression spring 49. The spring 49 is partially compressed producing a rearward force which holds the carriage 41 against a stop on the front face 45 of the hub 6. When the turbine is spinning the flyweights 21 exert a forward force on the carriage 41 against the spring pressure. At a predetermined speed, the flyweights 21 overcome the spring force and the carriage 41 starts moving forward.

Attached to carriage 41 are a series of connecting rods 46 which are connected to lever arm 47 on each blade support shaft 40. The blade support shafts 40 are mounted around the hub 6 on bearings (not shown) allowing the turbine blades to rotate about the blade pitch axis. Fore and aft movement of the carriage 41 is translated by connecting rods 46 into rotation about the blades pitch axis. Forward movement of the carriage 41 produces an increase in blade pitch. Therefore outwards movement of flyweights 21 translates into increased blade pitch angle.

The connecting rods 46 are attached to a small sleeve 48 that is attached to the carriage 41 by a bearing surface such that the small sleeve 48 can slide fore and aft on the carriage 41. A second compression spring 50, that is smaller than the flyweight spring 49, is located on the carriage 41 forward of the sleeve 48. The second small spring 50 remains compressed by a small amount so that the sleeve 48 is held aft against a stop on the carriage 41. This arrangement allows the blade pitch angle to momentarily increase in response to a sudden twisting moment acting on the turbine blades (such as the aerodynamic force resulting from a strong gust of wind) by compressing the smaller spring 50 instead of having to overcome the force associated with the main flyweight spring 49. This permits a rapid momentary adjustment of blade pitch angle in response to sudden wind gusts. The blade pitch angle is maintained for the duration of the wind gusts. The mechanism permits the turbine blades to be adjusted in unison. Movement of sleeve 48 in either a fore or aft direction along driveshaft 43 results in substantially even movement of each connecting rod 46 and blade support shaft 40. This combined motion results in substantially even pitch adjustment of each blade, which is preferable as it avoids imbalance and unequal force distribution.

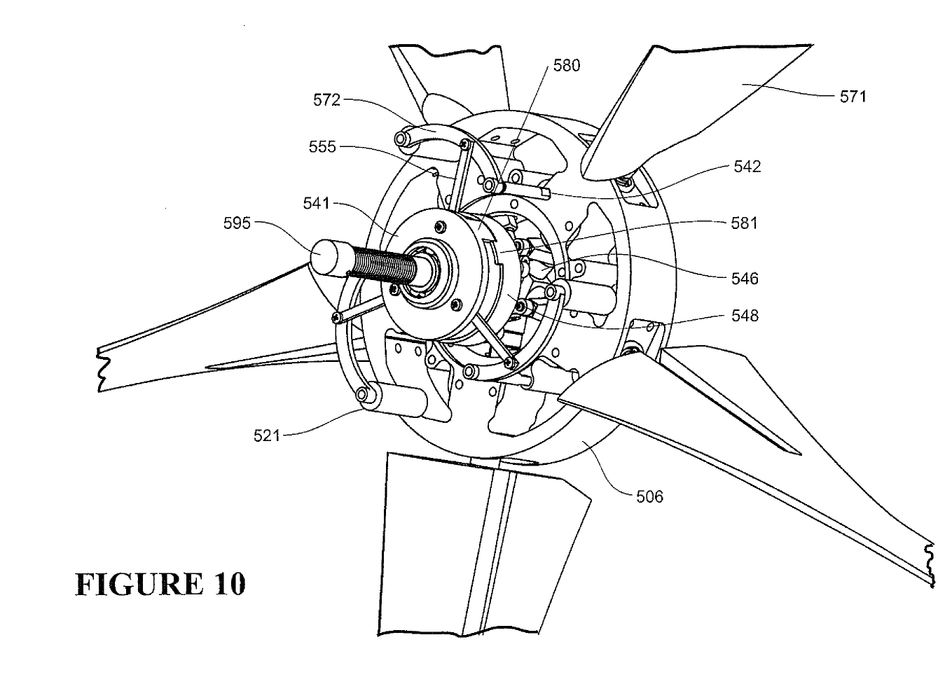

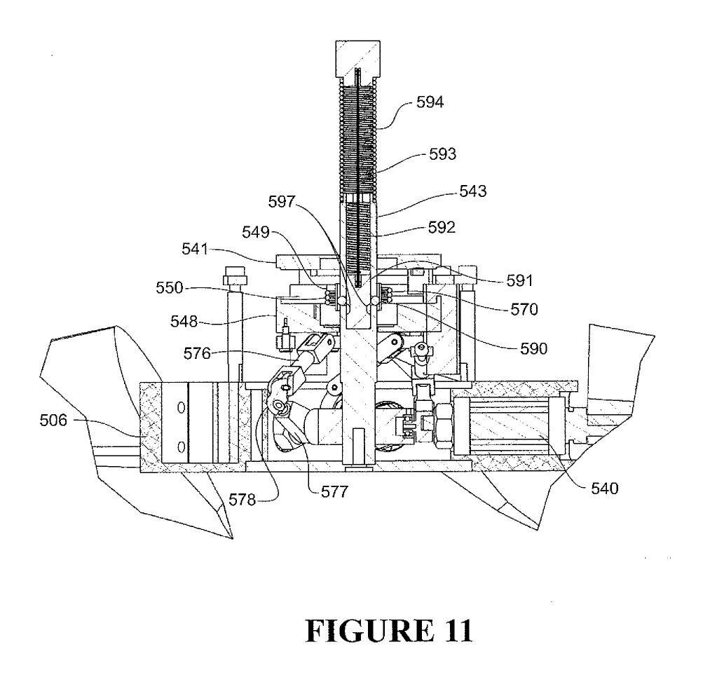

A second embodiment of the present invention is pictured in FIGS. 10 and 11. The flyweight governor of this embodiment differs from the previous embodiment in the elastic linkage experiences predominantly rotational motion in response to the aerodynamic forces acting on the turbine blade (in place of the translation motion of carriage 41 and sleeve 48 of the previous embodiment).

In this embodiment, flyweights 521 impart a rotational motion on flyweight rotor 541 through flyweight rotor linkages 555. The flyweights 521 shown in FIG. 10 are in a substantially fully extended position, which corresponds to the turbine blades in a feathered arrangement. Flyweights 521 are connected to hub 506 via pivot arms 542. In use, rotation of flyweights 521 with hub 506 results in a centrifugal force which acts outwardly from the axis of rotation (substantially collinear with shaft 543). When the rotational speed of flyweights 521 reaches a calibrated limit, they begin to move outwardly from shaft 543. The path of motion of flyweights 521 is dictated by flyweight pivot linkage 572 and flyweight rotor linkage 555. Flyweight rotor linkage 555 is pivotably mounted to both flyweight pivot linkage 572 and flyweight rotor 541. The outward force of flyweights 521 is transmitted through flyweight rotor linkage 555 to rotor 541 causing it to rotate. The rotation of flyweight rotor 541, and accordingly the motion of flyweights 521, is opposed by flyweight torsion spring 549. As the motion of flyweights 521 is directly affected by the resistive force provided by flyweight torsion spring 549, the rotational speed of the turbine at which feathering starts can be calibrated by selecting flyweight torsion spring 549 to have a restrictive torsional force in proportion to the centrifugal force acting on flyweights 521 at the desired speed.

The motion of flyweight rotor 541 is transferred to blade control rotor 548 through corresponding abutments 580 and 581. The rotary motion of blade rotor 548 is then transformed through 90° from an axis of rotation substantially aligned with shaft 543 to the individual blade shaft assembly 540 by pitch control linkage 578. Pitch control linkage 578 comprises conrod linkage 576 and pitch control lever 577.

In the embodiment pictured in FIG. 10, abutments 580 and 581 act to transmit clockwise rotational motion from flyweight rotor 541 to blade control rotor 548. In consistent wind conditions when the turbine is operating at rotational speeds less than those required to activate the flyweight governor, the blade pitch angle is effectively constant. In this situation, flyweight rotor 541 is held stationery against a constant pitch stop (not shown). The action of flyweight rotor abutment 580 on blade control rotor abutment 581 limits the rotation of blade control rotor 548 in a single direction (the particular direction of limitation is not considered essential). In the representation pictured in FIG. 10, anticlockwise rotation of blade control rotor 548 is limited. However, the action of abutment 580 and 581 do not prevent blade control rotor 548 from rotating in the other direction (clockwise in FIG. 10). A second torsional spring, blade control spring 550, opposes rotation of blade control rotor 548 in this direction. The opposing force provided by blade control spring 550 is comparatively less than that of flyweight torsional spring 549. Thus blade control spring 550 functions analogously to compression spring 50 of the earlier embodiment of the flyweight governor, permitting momentary adjustment of the blade pitch in response to wind gusts.

### Turbine Blades

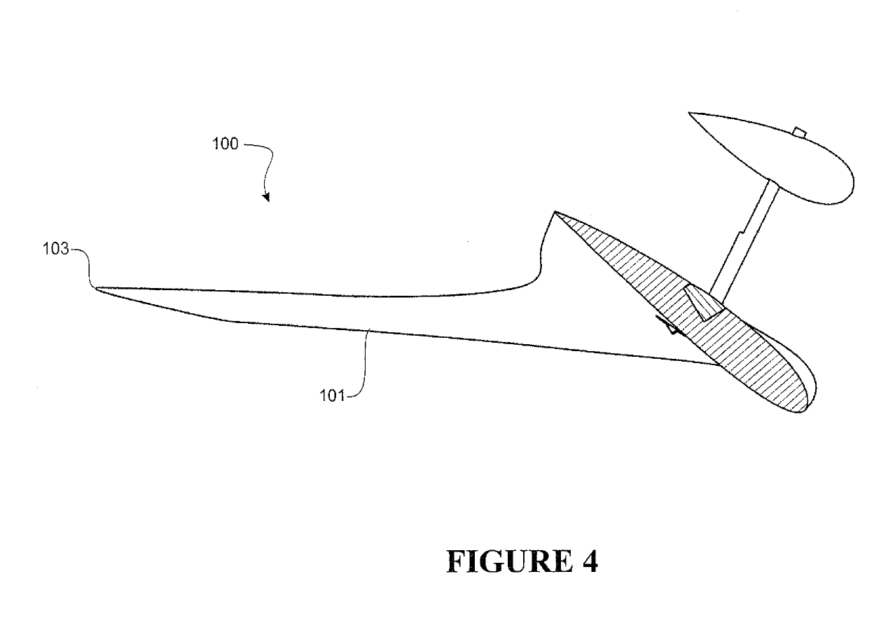

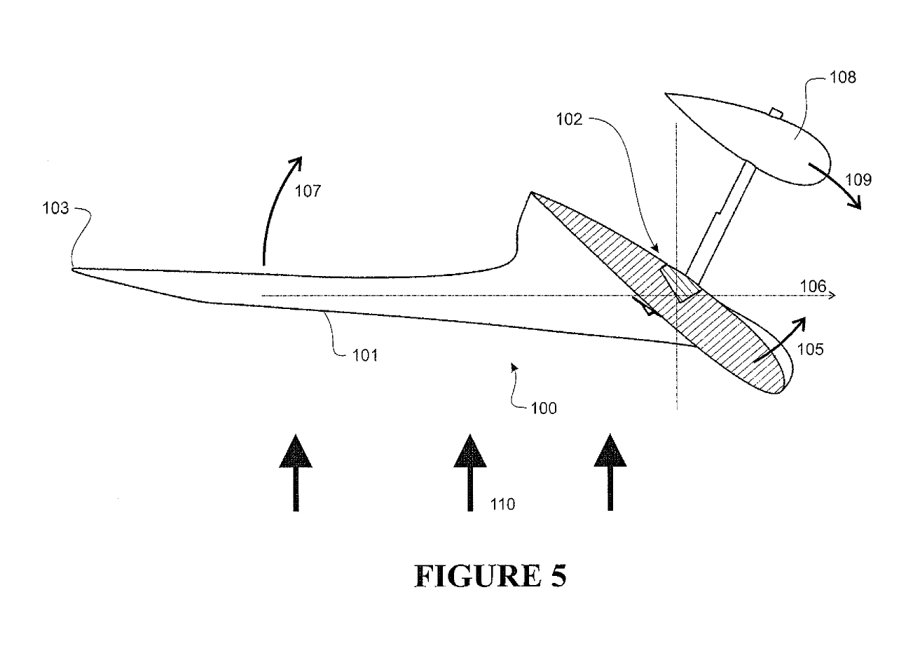

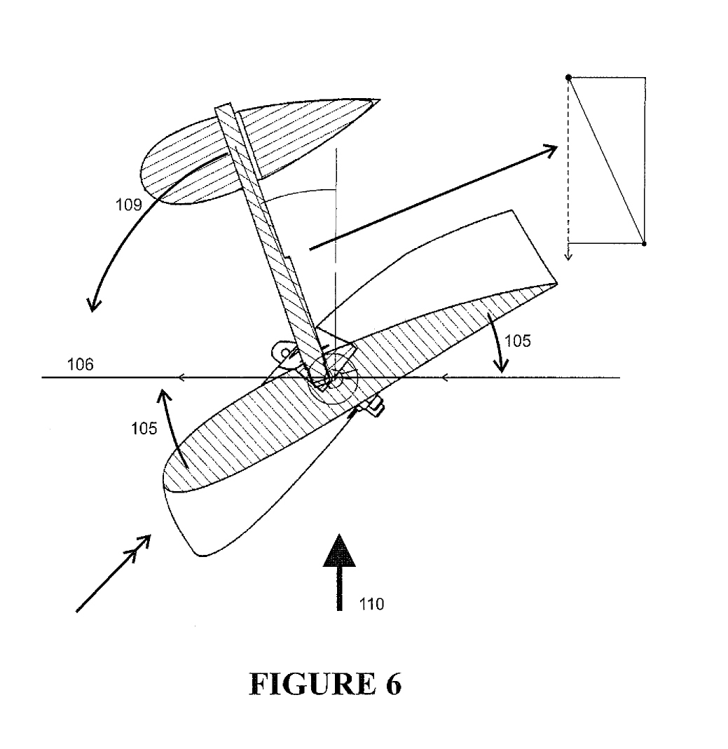

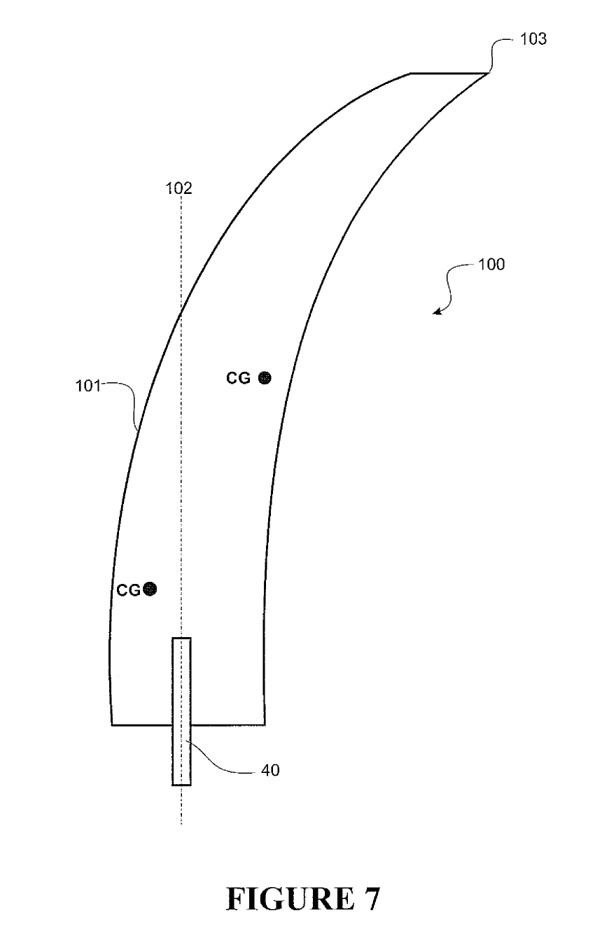

With reference to FIGS. 4 to 6, the turbine blades 100 are designed and configured with a swept back “scimitar” style curve shape. The blade support shafts 40 are located on the turbine hub 6 onto which the turbine blades 100 are mounted. It is preferable that the turbine blades 100 are each located with approximately 30-50% of the blade root chord length positioned aft of the turbine blade leading edge 101 as shown in FIG. 7. This results in the majority of the blade area lying in a plane behind the blade pitch axis 102 than in front, particularly nearer the tip 103 of the turbine blade 100. With this blade configuration, a sudden wind gust shown by arrows 110, will cause a pitching moment 107 about the blade pitch axis 102. If the pitching moment 107 is sufficient to overcome the small spring 50 biasing force, then the turbine blades 100 will be able to increase in blade pitch and relieve the horizontal gust force.

### Counterweight Attachment to the Turbine Blades

There is another force which would contrive to oppose the gust relieving pitching moment, especially at higher wind turbine speeds. This force is the centrifugal turning or twisting moment (CTM) 105. All elements of the blade 100 that don't lie exactly on the plane of rotation 106 of the turbine 1 are subject to a centrifugal force which tries to move those elements towards the plane of rotation 106. The CTM force 106 has the effect of producing a turning moment about the blade pitch axis 102, but in the decrease pitch direction. This is undesirable as it opposes the increased pitch force of the flyweights 21. At high blade rotational speeds this force becomes very powerful and surpasses aerodynamic forces on the blades 100.

Hence, at low turbine RPM the gust protection arrangement will work satisfactorily but will cease to be effective as the turbine RPM increases and CTM 105 becomes the dominant force acting on the blade 100. The CTM 105 must be neutralised in order for the gust protection system to work throughout the entire speed range of the turbine 1.

This can be achieved by adding a CTM counterweight 108 to each blade 100 in a position such that it will oppose the blade CTM 105. As the counterweight 108 produces a centrifugal turning moment CTM 109 in opposition to the blade CTM 105, the opposing forces balance each other over the entire RPM range. Therefore, by neutralising the CTM 105 using a counterweight 108, the blades 100 can react to sudden gusts throughout the turbine speed range.

A further benefit of using counterweights 109 is that the force required by the wind turbine over speed governor is much less thereby allowing the gust protection components to be made smaller and lighter.

At low to mid turbine RPM ranges a sudden gust of wind will cause the blades 100 to twist towards feather. The connecting rods 46 of each blade 100 will drive the sleeve 48 forward and cause the small spring 50 to compress. At these speeds the larger flyweight spring 49 holds the carriage 41 fully aft on the driveshaft 8. As the turbine RPM increases the flyweights 21 apply an increasing force against the large flyweight spring 49. Therefore, if a gust of wind occurs the carriage 41 may move forward with the sleeve 48 as the smaller sleeve spring 50 requires a greater force to compress than the larger flyweight spring 49.

The position of the counterweight 109 can vary considerably and is dependent on the desired effects on the wind turbine 1 when wind strikes the turbine blades 100. It is preferable to locate the counterweight 109 close to the blade root as the centrifugal forces are less in this position while the turning force remains substantially the same. Placing an identical counterweight near the blade tip 103 will produce exactly the same turning force, but the total centrifugal forces on the blade 100 will be much greater.

The counterweight 109 can alternatively be located in front of or behind the blade 100. If the counterweight 109 is external of the wind turbines housing (body) and therefore exposed to the blade slipstream then mounting the counterweight 109 behind the blade 100 is preferable as it will not disturb the airflow impinging on the blade 100. Furthermore, there will be a small bending relief on the blade 100.

It is preferable that the counterweight 109 is located at a suitable angle relative to the blade pitch axis 102. For example, if the counterweight 109 is located behind the blade 100 then it must be positioned 20 or 30° forward relative to the turbine fore/aft axis. This angle determines the moment arm that the counterweight 109 applies to the blade pitch axis 102. If the angle is larger such as 45-60°, then the turning force will be effective over a smaller blade pitch range. Furthermore, as the counterweight 109 approaches the plane of rotation 106 of the blade 100, the turning force diminishes towards zero.

### Calculation

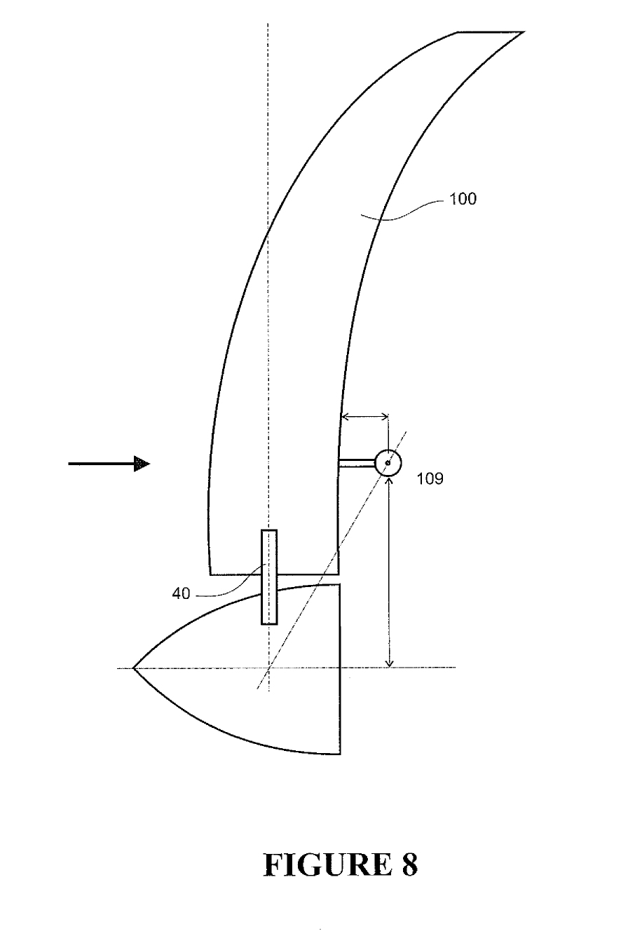

The counterweight 109 is subject to a centrifugal force outwards due to centripetal acceleration created due to rotation of the blade 100. With reference to FIG. 8:

Centrifugal force(F)=counterweight acceleration(V²/R)×Counterweight mass(M)

where:

Velocity(V)=(blade RPM/60)×2πR(metres per second)

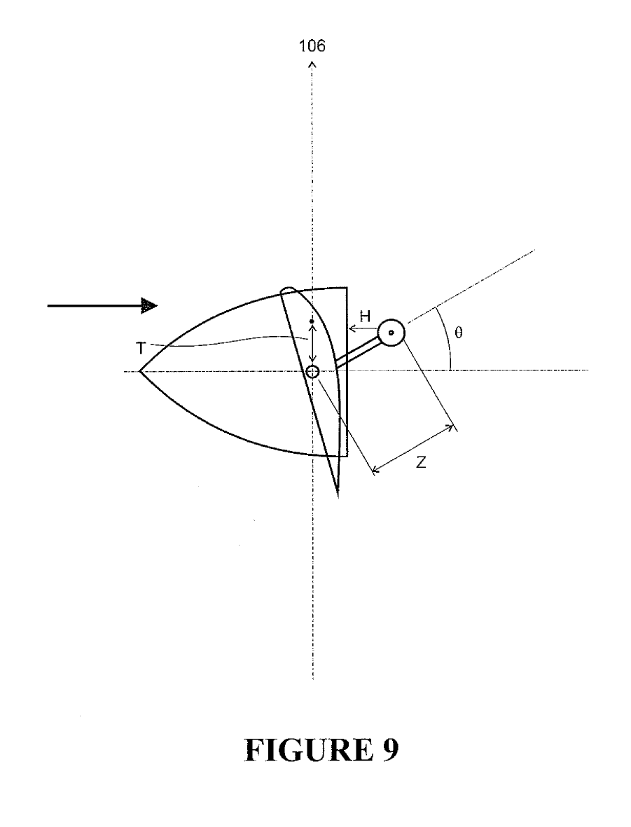

The horizontal component of Force F(H)=F sin(a)

where
a=the angle between the plane of rotation 106 and the centre of rotation of the counterweight 109. This force component provides the centrifugal turning moment provided by the counterweight 109. Furthermore, with reference to FIG. 9, the torque generated by the counterweight 109 is calculated as follows:

Torque=Force×perpendicular distance and therefore:

Torque=Horizontal Force(F(H))×distance(T)

where

T=Z Sin(θ)

where
Z=distance from the plane of rotation 106 and the centre of rotation of the counterweight 109. The angle θ depends on the specific wind turbine design requirements and relates to how many degrees of blade pitch increase (feathering) are desired. The greatest torque value is achieved when θ equates to 45°. In practice however, an angle θ of 30 to 35° would be more desirable so that the torque will increase as the counterweight 109 moves towards 45°. At angles greater than 45°, the torque value diminishes.

### Turbine Imbalance Shutdown Mechanism

General wind turbine operation requires a high degree of dynamic balance. Because of the generally high rotational speeds and extended operating periods, dynamic imbalances can eventuate in significant damage to the turbine and supporting structure. The effect of such out of balance forces can be intensified by continued operation of the turbine after an imbalance occurs. Additionally, extreme weather conditions can affect a sudden out of balance condition by inflicting damage to the turbine (such as the loss of a blade). In instances of severe imbalance, the turbine can rapidly degenerate to a state of irrepair as a result of the drastically increased stress levels.

An embodiment of an imbalance shut down mechanism is pictured in FIGS. 11, 12 and 13. The mechanism is described with reference to the rotary embodiment of the gust protection device, however it would by equally applicable to the translating embodiment, and in fact the implementation is analogous. It is intended that this mechanism prevent sever imbalances from effectively destroying the turbine. The mechanism functions by removing the restrictive forces on flyweight torsion spring 549 and blade control torsion spring 550. This is achieved by releasing the force preventing the springs 549, 550 from rotating, and releasing the preloaded force on flyweight rotor 541 and blade control rotor 548.

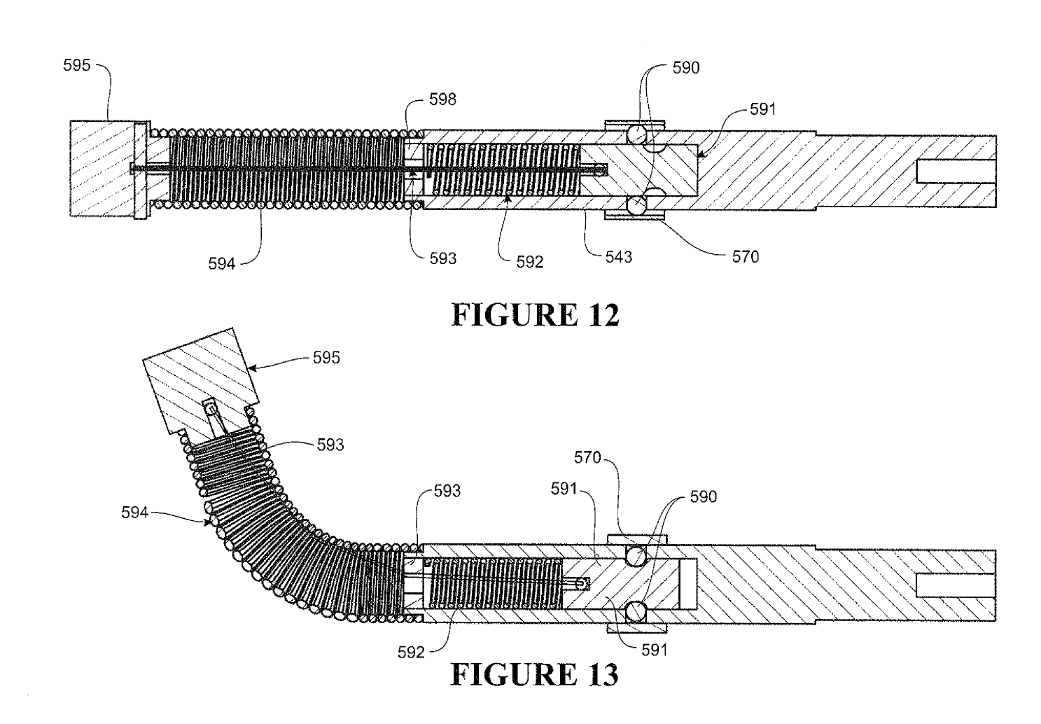

The imbalance shutdown mechanism is pictured in more detail in FIGS. 12 and 13. FIG. 12 depicts the mechanism in the unactivated or untripped, state indicative of regular operation of the turbine. FIG. 13 represents the mechanism in a recently tripped or activated state, with coil spring 594 still partially extended. Both flyweight torsions spring 549 and blade control torsion spring 550 are mounted on torsion spring sleeve 570, which is concentrically located over shaft 543 between flyweight rotor 521 and blade control rotor 548. During regular operation, torsion spring sleeve 570 is circumferentially located on shaft 543 by locking balls 590, which protrude through holes located in shaft 543. Locking balls 590 engage hemispherical grooves or channels longitudinally arranged on the inner surface of torsion spring sleeve 570. During regular operation of the wind turbine, locking balls 590 are retained within the holes provided in shaft 543 by the action of torsion spring sleeve 570 on an outer side and piston 591 on an inner side. The holes in shaft 543 are appropriately sized to prevent substantial movement of locking balls 590 in circumferential or longitudinal directions (with respect to shaft 543).

Piston 591 is located within a hollow portion of shaft 543 adjacent torsion spring sleeve 570. Abutment of locking balls 590 against the outer surface of piston 591 retains locking balls 590 in engagement with the hemispherical grooves located on the inner surface of torsion spring sleeve 570. This prevents torsion spring sleeve 570 from rotating under the action of flyweight torsion spring 541 and blade control torsion spring 550.

Piston 591 is located within shaft 543 by the opposing forces of piston spring 592 and cable 593. Piston spring 592 is in a constant state of compression between pistons 591 and abutments 598 provided at the fore end of shaft 543. Cable 593 is connected to the fore end of piston 591 and the aft end of weight 595, which is itself connected to the fore end of extension coil spring 594. Finally, the aft end of extension coil spring 594 is attached to the fore end of shaft 543.

Extension coil spring 594 is substantially aligned with shaft 543 such that it rotates about its coil axis during regular operation of the turbine. Under the action of a turbine imbalance, weight 595 is subjected to an unbalanced radial force which causes deflection of coil spring 594. With a significant imbalance in excess of a calibrated limit, the unbalanced forces acting on weight 595 cause coil spring 594 to bend over which increases the tension force on cable 593.

Piston compression spring 592 is sized such that a tension force on cable 593 above a calibrated threshold causes movement of piston 591 in a fore direction. Such calibration is achieved by matching the compressive forces of piston spring 592 and bending force of coil spring 594 to the anticipated tension forces in cable 593 resulting from a predetermined level of imbalance.

Hemispherical notches 597 are recessed into the outer surface of piston 591. During regular operation of the turbine, notches 597 are located aft the locking ball holes in shaft 543. However, under the action of an imbalance, fore movement of piston 591 brings notches 597 substantially into alignment with locking balls 590. Locking balls 590 are then able to retract into hemispherical notches 597 as pictured in FIG. 13. This releases the rotational restriction acting on torsion spring sleeve 570, which is then able to rotate under the combined action of flyweight rotor 521 and blade control rotor 548.

Thus, in conditions of severe imbalance, the force regulating the pitch of the turbine blades 100 in response to the rotational speed of the turbine is removed, and the blades are forced to “feather” by the action of the unrestrained flyweight governor and the aerodynamic forces of the wind. This results from the released motion of flyweight rotor 521 and blade control rotor 548 within the allowable range of pitch configurations, and prevents the turbine from extracting further significant energy from the wind. Additionally, the movement of the flyweights away from the centre of rotation increases the rotational inertia of the turbine, causing a rapid deceleration.

This method of detecting an imbalance can also be used on the linear carriage type governor. The piston and locking balls arrangement will lock a small sleeve located on the driveshaft, which forms the forward stop for the main governor spring. Removing the locking balls will decompress the spring, allowing the flyweights to open fully and feather the blades.

After activation of an imbalance shut down mechanism, the turbine will effectively be inoperable until the mechanism can be reset. This prevents an imbalance from causing sever damage to the turbine and supporting structure without user intervention.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

1. A wind turbine comprising a plurality of feathering blades, where each blade includes a shape having a leading and a trailing edge, and the blade has a centre of pressure that is displaced from the blade pitch axis in the direction of the trailing edge of the blade so that wind force on the blade urges feathering of the blade, a governor for controlling the pitch angle of the blades according to the speed of rotation of the turbine, and an elastic linkage between the governor and the blades, the linkage urging the blades toward the pitch position set by the governor, allowing pitching of the blades toward a more feathered position than a position set by the governor against an elastic return force, and not allowing substantial pitching of the blades to a less feathered position than the position set by the governor; such that a governor sets the minimum pitch angle of the blades, but the blades can react immediately to additional wind pressure by self feathering against the urging of the elastic linkage.

2. A wind turbine as claimed in claim 1 wherein the linkage acts on the blades collectively.

3. A wind turbine as claimed in claim 2 wherein the blades are mounted in a hub, each blade to rotate around a respective pitch axis, the governor includes a pitch control member, the position of the pitch control member relative to the hub changes according to turbine speed, and the linkage includes a blade control member, the position of the blade control member relative to the hub changing according to blade pitch of the blades, the position of the pitch control member setting a limit position for the blade control member, and a spring urging the blade control member toward this limit position, and providing a preload force against movement of the blade control member away from this limit position.

4. A wind turbine as claimed in claim 3 wherein each blade is balanced such that centrifugal turning moment around the pitch axis of the blade, generated by rotation of the turbine, at speeds throughout the useful speed range for the turbine is more than countered by the moment provided by wind force on the blade at that speed.

5. A wind turbine as claimed in claim 4 wherein each blade includes a blade body and a counter weight near the root of each blade body sized and located to balance the centrifugal turning moment of the blade.

6. A wind turbine as claimed in any one of claims 3 to 5 wherein the pitch axes of each blade all fall in a single plane.

7. A wind turbine as claimed in any one of claims 3 to 6 wherein the governor includes a plurality of pivoting flyweights, that orbit around the rotation axis of the hub, and the flyweights can move outward against a spring force with increasing rotation speed of the hub, outward position of the flyweights controlling the position of the pitch control member.

8. A wind turbine as claimed in any one of claims 3 to 6 wherein a drive shaft extends from the hub, the governor includes a plurality of flyweights pivotably connected to the drive shaft and interconnected to the pitch control member by a plurality of links, and the pitch control member is able to move along the axis of the drive shaft, and the position of the pitch control member along the drive shaft is controlled by the outward displacement of the flyweights.

9. A wind turbine as claimed in claim 8 wherein the governor includes a partially compressed spring acting on the pitch control member urging the pitch control member toward an unfeathered position.

10. A wind turbine as claimed in claim 8 wherein the blade control member is able to move along the axis of the drive shaft and a partially compressed spring acts between the blade control member and the pitch control member.

11. A wind turbine as claimed in claim 10 wherein the blade control member is a sleeve concentric with the pitch control member and able to slide along the pitch control member, and abuts a portion of the pitch control member at one end of the sliding movement, the partially compressed spring urging the blade control member to this end.

12. A wind turbine as claimed in claim 11 wherein the partially compressed spring is compressed between a collar on the pitch control member and a portion of the sleeve.

13. A wind turbine as claimed in any one of claims 8 to 12 wherein the spring urging the pitch control member to the unfeathered position is stiffer than the spring acting between the pitch control member and the blade control member.

14. A wind turbine as claimed in any one of claims 3 to 6 wherein a drive shaft extends from the hub, the governor includes a plurality of flyweights pivotably connected to the drive shaft or hub to swing outward about a hinge axis parallel with the drive shaft rotation axis, and interconnected to the pitch control member by a plurality of links, and the pitch control member is annular and is able to rotate around the axis of the drive shaft, and the rotational position of the pitch control member around the drive shaft is controlled by the outward displacement of the flyweights.

15. A wind turbine as claimed in claim 14 wherein the governor includes a preloaded torsion spring acting on the pitch control member urging the pitch control member toward unfeathered rotational position.

16. A wind turbine as claimed in claim 14 or claim 15 wherein the blade control member is annular and is able to rotate around the axis of the drive shaft and a preloaded torsion spring acts on the blade control member urging the blade control member to an unfeathered condition.

17. A wind turbine as claimed in claim 15 wherein the blade control member is annular and is able to rotate around the axis of the drive shaft and a preloaded torsion spring acts on the blade control member urging the blade control member to an unfeathered condition, and the spring urging the pitch control member to the unfeathered position is stiffer than the spring acting to urge the blade control member toward the unfeathered condition.

18. A wind turbine as claimed in claim 16 or claim 17 wherein the torsion spring acting on the blade control member is constrained at one end by a sleeve concentric with the shaft and the sleeve is usually locked to rotate with the shaft, the turbine including a release control to release the sleeve to rotate relative to the shaft.

19. A wind turbine as claimed in claim 15, or claim 17 wherein the torsion spring acting on the blade control member is constrained at one end by a sleeve concentric with the shaft and the sleeve is usually locked to rotate with the shaft, the turbine including a release control to release the sleeve to rotate relative to the shaft.

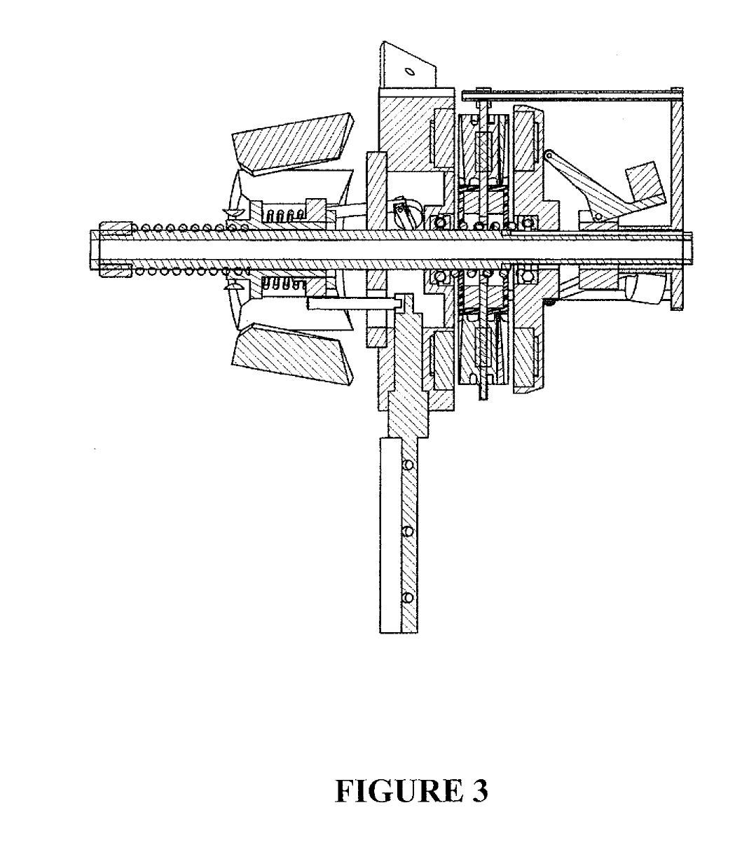

20. A wind turbine including a gust protection mechanism substantially as herein described with reference to the drawings FIG. 1 to FIG. 11.
